(19) United States
(12) Patent Application Publication
(10) Pub. No.: US 2026/0358584 A1
(43) Pub. Date: Nov. 12, 2026

(54) OPTICAL COMPONENT AND OPTICAL MODULE

(71) Applicant: SUMITOMO ELECTRIC INDUSTRIES, LTD., Osaka (JP)

(72) Inventors: Shun ENDO, Osaka (JP); Masaki SUZUKI, Osaka (JP); Takeshi INOUE, Osaka (JP)

(73) Assignee: SUMITOMO ELECTRIC INDUSTRIES, LTD., Osaka (JP)

(21) Appl. No.: 19/665,232

(22) Filed: May 1, 2026

(30) Foreign Application Priority Data
May 9, 2025 (JP) 2025-078567

(51) Int. Cl. G02B 6/42

(52) U.S. Cl. CPC G02B 6/4262; G02B 6/4214; G02B 6/426

(57) ABSTRACT

An optical component according to an embodiment is configured to be attached to a substrate extending in a first direction and a second direction intersecting the first direction and having a thickness in a third direction intersecting the first direction and the second direction. The optical component according to an embodiment includes a lens component including an optical-fiber-coupling portion, a mirror portion and a lens portion, the optical-fiber-coupling portion being a portion to which an optical fiber extending in the first direction is connected, the mirror portion reflecting light emitted from the optical fiber, the lens portion through which the light reflected by the mirror portion passes, and a cover covering the lens component along the third direction. At a portion other than the optical-fiber-coupling portion, the lens component includes a region covering an element mounted on the substrate between the lens component and the substrate.

### CROSS REFERENCE TO RELATED APPLICATIONS

This application claims priority based on Japanese Patent Application No. 2025-078567 filed on May 9, 2025, and the entire contents of the Japanese patent application are incorporated herein by reference.

### TECHNICAL FIELD

The present disclosure relates to an optical component and an optical module.

### BACKGROUND

Patent literature 1 (Japanese Unexamined Patent Application Publication No. 2022-135003) describes an optical connector cable. The optical connector cable includes a plurality of optical fibers, a lens module having a placement structure for placing the plurality of optical fibers and a plurality of lenses optically coupled to each of tip ends of the plurality of optical fibers, and an adhesive portion fixing the plurality of optical fibers to the placement structure. The adhesive portion include a first adhesive portion located near the tip ends of the plurality of optical fibers and a second adhesive portion located behind the first adhesive portion.

Patent literature 2 (Japanese Unexamined Patent Application Publication No. 2022-61168) describes an optical connector cable. The optical connector cable includes a plurality of optical fibers, a lens module, and an adhesive. The lens module has a placement portion on which end portions of the plurality of optical fibers are placed, a facing surface that faces the plurality of optical fibers, and a plurality of lenses that are optically coupled to each of the plurality of optical fibers.

Patent literature 3 (WO 2023/013349) describes an optical module. The optical module includes a substrate, an optical element mounted on the substrate, and a lens module. The lens module has an outer surface, an inner surface, and a lens optically coupled to the optical element. The lens module optically couples the optical fiber to the optical element through the lens.

### SUMMARY

An optical component according to the present disclosure is configured to be attached to a substrate extending in a first direction and a second direction intersecting the first direction and having a thickness in a third direction intersecting the first direction and the second direction. The optical component includes a lens component including an optical-fiber-coupling portion, a mirror portion and a lens portion, the optical-fiber-coupling portion being a portion to which an optical fiber extending in the first direction is connected, the mirror portion reflecting light emitted from the optical fiber, the lens portion through which the light reflected by the mirror portion passes, and a cover covering the lens component along the third direction. At a portion other than the optical-fiber-coupling portion, the lens component includes a region covering an element mounted on the substrate between the lens component and the substrate. The cover includes a top surface extending in the first direction and the second direction and an end surface extending from the top surface in the third direction and facing the region of the lens component in the first direction.

### BRIEF DESCRIPTION OF THE DRAWINGS

FIG. 1 is a cross-sectional view schematically showing an optical component and an optical module according to an embodiment.

FIG. 2 is a perspective view showing an optical component and an optical module according to an embodiment.

FIG. 3 is a perspective view of an optical component and an optical module according to an embodiment when viewed in a direction different from that of FIG. 2.

FIG. 4 is a perspective view showing a lens component of an optical component according to an embodiment.

FIG. 5 is a perspective view showing an optical component and an optical module according to a modification.

FIG. 6 is a perspective view showing an optical component and an optical module according to a modification different from that of FIG. 5.

FIG. 7 is a perspective view showing an optical component and an optical module according to a modification different from that of FIG. 5 and FIG. 6.

FIG. 8 is a cross-sectional view schematically showing an optical component and an optical module of FIG. 7.

### DETAILED DESCRIPTION

In an optical component having a mirror that reflects light emitted from an optical fiber and a lens through which the light reflected by the mirror passes, a region in which an element such as a photoelectric conversion element or a driver IC is mounted may be provided between the optical component and a substrate. In this case, a foreign matter such as dust may enter the region where the element is mounted from the outside, and there is a possibility that the foreign matter may enter the periphery of the element. Thus, it is required to reduce the entry of the foreign matter.

An object of the present disclosure is to provide an optical component and an optical module capable of reducing the entry of foreign matter.

According to the present disclosure, the entry of foreign matter can be reduced.

First, embodiments of an optical component and an optical module according to the present disclosure will be listed and described. (1) An optical component according to the present embodiment is configured to be attached to a substrate extending in a first direction and a second direction intersecting the first direction and having a thickness in a third direction intersecting the first direction and the second direction. The optical component includes a lens component having an optical-fiber-coupling portion, a mirror portion and a lens portion, the optical-fiber-coupling portion being a portion to which an optical fiber extending in the first direction is connected, the mirror portion reflecting light emitted from the optical fiber, the lens portion through which the light reflected by the mirror portion passes, and a cover covering the lens component along the third direction. At a portion other than the optical-fiber-coupling portion, the lens component includes a region covering an element mounted on the substrate between the lens component and the substrate. The cover includes a top surface extending in the first direction and the second direction and an end surface extending from the top surface in the third direction and facing the region of the lens component in the first direction.

The optical component includes the lens component and the cover. The lens component has the optical-fiber-coupling portion, the mirror portion, and the lens portion. The lens component has the region covering the element mounted on the substrate, and the cover covers the lens component along the third direction which is a thickness direction of the substrate. Thus, it is possible to reduce the entry of foreign matter into the lens component. The cover has the top surface and the end surface, and the end surface faces the region covering the element in the first direction. Thus, it is possible to make it difficult for a foreign matter to enter the region covering the element mounted on the substrate, which is provided between the lens component and the substrate, from the outside, and thus it is possible to more reliably reduce the entry of the foreign matter into the periphery of the element.

(2) In the above (1), the cover may further include a first side surface extending in the third direction from an end of the top surface in the second direction, and a second side surface extending in the third direction from an end of the top surface in a direction opposite to the second direction. In this case, the first side surface and the second side surface of the cover can make it difficult for foreign matter to enter the region covering the element mounted on the substrate, which is provided between the lens component and the substrate, from the outside.

(3) In the above (1), the cover may include a third side surface extending in the third direction from an end of the top surface in a direction opposite to the first direction, and a recessed portion that is a portion recessed in the first direction from an end of the third side surface in a direction opposite to the third direction and is a portion where the optical-fiber-coupling portion is exposed. In this case, the optical-fiber-coupling portion of the lens component is exposed at the recessed portion of the cover. Thus, the optical fiber can be easily connected to the optical-fiber-coupling portion.

(4) In any one of the above (1) to (3), the cover may include a latch portion that engages with the lens component. In this case, since the latch portion of the cover is engaged with the lens component, the cover can be firmly fixed to the lens component.

(5) In any one of the above (1) to (4), the lens component may include an engagement portion protruding from the lens component in the second direction and engaged with the latch portion. In this case, since the lens component has an engagement portion with which the latch portion of the cover is engaged, the engagement of the cover with respect to the lens component can be strengthened.

(6) In any one of the above (1) to (5), the cover may be made of metal. In this case, electrical noise can be less likely to leak from the element to the outside of the cover. Further, since the cover can be manufactured by bending or punching, the cost of the cover can be reduced.

(7) In any one of the above (1) to (5), the cover may be made of resin. In this case, the cover can be manufactured by injection molding using a mold, and thus the cover can be easily manufactured.

(8) In any one of the above (1) to (7), the cover may be provided with a depression that forms a gap between the cover and the substrate. In a case where a signal line is provided on the substrate, the depression can reduce degradation of signal characteristics and occurrence of a communication failure due to contact of the cover with the signal line provided on the substrate.

(9) In any one of the above (1) to (8), the lens component may be transparent. The cover may be provided with a through hole penetrating the cover in the third direction. In this case, since a portion of the substrate serving as a mark can be seen through the through hole of the cover, the optical component can be easily aligned with respect to the substrate.

(10) In any one of the above (1) to (8), the lens component may be made of resin. The mirror portion may be at a boundary portion between resin and air. The cover may cover the mirror portion when viewed in the third direction. In this case, the mirror portion at the boundary portion between resin and air is covered by the cover, so that the entry of the foreign matter into the mirror portion can be reduced. Thus, it is possible to reduce the decrease in the reflectance of the mirror portion due to the foreign matter. Further, when both the lens component and the cover are made of resin, the lens component and the cover can be easily bonded to each other with an adhesive.

(11) An optical module according to an embodiment includes the optical component described above, and the substrate to which the optical component is attached. Similar effects to those of the optical component described above can be obtained from this optical module.

(12) In the above (11), the cover may include a connecting portion connected to the substrate through solder. In this case, the cover has the connecting portion connected to the substrate through solder. In this case, the cover can be connected to ground.

(13) In the above (11) or (12), the cover may include a plurality of the connecting portions connected to the substrate. The plurality of the connecting portions may include a first connecting portion located at an end of the cover in the first direction and a second connecting portion located at an end of the cover in a direction opposite to the first direction. In this case, the cover can be fixed to the substrate at each of the end of the cover in the first direction and the end of the cover in the direction opposite to the first direction, and thus the cover can be electrically stably connected to ground. Further, since the cover is fixed to the substrate at each of the end of the cover in the first direction and the end of the cover in the direction opposite to the first direction, the cover can be made less likely to be inclined with respect to the substrate.

(14) In the above (13), the substrate may include a through portion penetrating in the third direction and a pad provided on a surface of the substrate. The first connecting portion may be connected to the substrate through solder at the through portion. The second connecting portion may be connected to the substrate through solder at the pad. In this case, the first connecting portion of the cover is connected to the substrate through solder at the through portion of the substrate, and the connection strength of the cover to the substrate can be increased.

(15) In the above (12), the substrate may include a through portion penetrating in the third direction. The connecting portion may be connected to the substrate through solder at the through portion. In this case, the connecting portion of the cover is connected to the substrate through solder at the through portion of the substrate, and the connection strength of the cover to the substrate can be increased.

Specific examples of an optical component and an optical module according to an embodiment of the present disclosure will be described below with reference to the drawings. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

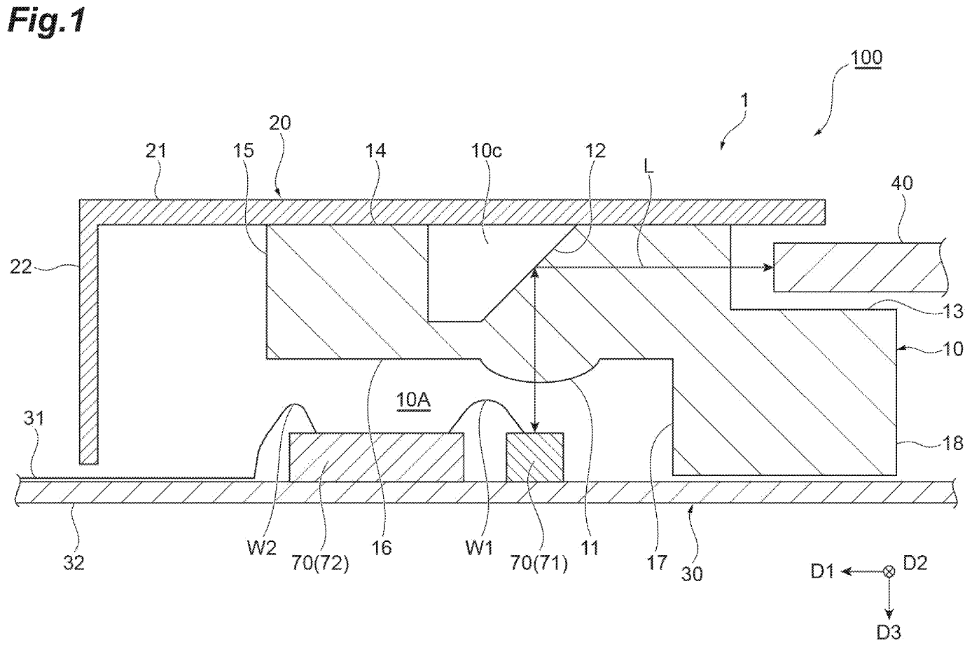

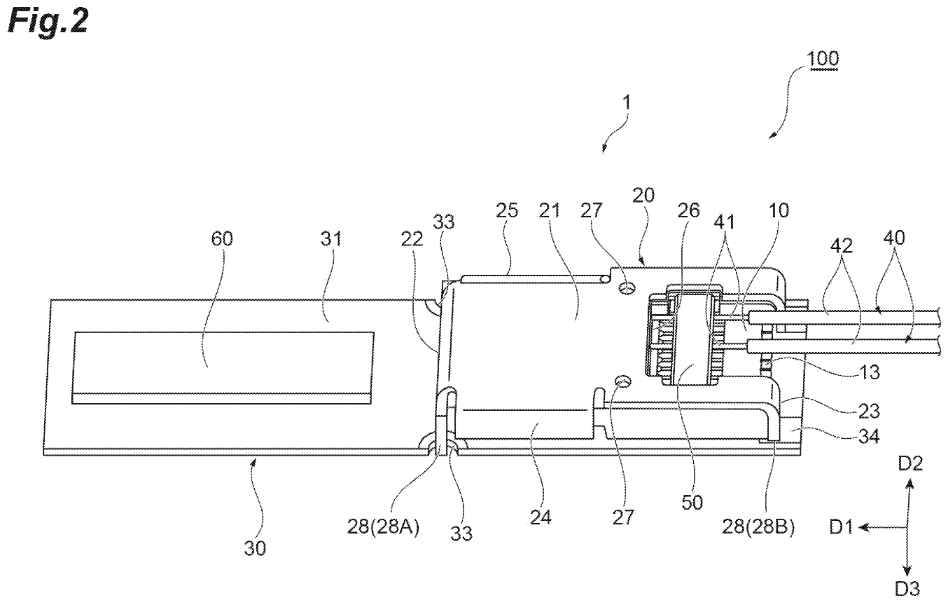

FIG. 1 is a cross-sectional view schematically showing an optical component 1 and an optical module 100 as an example according to an embodiment. FIG. 2 is a perspective view showing the optical module 100. As shown in FIG. 1 and FIG. 2, the optical module 100 includes the optical component 1 and a substrate 30 to which the optical component 1 is attached. The substrate 30 extends in a first direction D1 and a second direction D2 intersecting the first direction D1. Note that FIG. 1 is a cross-sectional view schematically showing a cross section of the optical module 100 when the optical module 100 is cut along a plane extending in the first direction D1 and a third direction D3 described later.

The substrate 30 is a circuit board. The substrate 30 has a thickness in the third direction D3 intersecting both the first direction D1 and the second direction D2. A length of the substrate 30 in the first direction D1 is, for example, greater than a length of the substrate 30 in the second direction D2. The length of the substrate 30 in the second direction D2 is, for example, greater than a length (thickness) of the substrate 30 in the third direction D3. The substrate 30 has a main surface 31 extending in the first direction D1 and the second direction D2, and a rear surface 32 opposite to the main surface 31. The optical component 1 is mounted on the main surface 31. For example, the optical module 100 includes a connector unit 60 mounted on the main surface 31. The connector unit 60 is located in the first direction D1 from the optical component 1.

The optical module 100 includes, for example, an element 70. The element 70 is mounted on the main surface 31 of the substrate 30. The element 70 is located inside the optical component 1. The optical module 100 includes, for example, a plurality of elements 70. The plurality of elements 70 are, for example, a photoelectric conversion element 71 and an IC 72. The photoelectric conversion element 71 is an example of the element 70, and the IC 72 is also an example of the element 70. As an example, the IC 72 is a driver IC. The photoelectric conversion element 71 is connected to the IC 72 through a bonding wire W1. The IC 72 is connected to a pad 34 of the substrate 30 through a bonding wire W2. The photoelectric conversion element 71 includes a light receiving element such as a photodiode (PD) and a vertical cavity surface emitting laser (VCSEL). The photoelectric conversion element 71 has an optical axis along the third direction D3.

The optical component 1 includes a lens component 10 and a cover 20 that covers the lens component 10 along the third direction D3. The cover 20 is provided to protect the lens component 10. As an example, the element 70 is disposed between the lens component 10 and the substrate 30. The lens component 10 is disposed so as to cover the element 70. The lens component 10 includes a region 10A covering the element 70 mounted on the substrate 30. The region 10A does not have to cover all of the photoelectric conversion element 71 and the IC 72. For example, the entire photoelectric conversion element 71 may be covered by the region 10A, and only a portion of the IC 72 may be covered by the region 10A. A portion of the IC 72 that is not covered by the region 10A may protrude from the region 10A in the first direction D1 or may protrude from the region 10A in the second direction D2. For example, the lens component 10 is transparent. The lens component 10 includes an optical-fiber-coupling portion 13 that is a portion to which an optical fiber 40 extending in the first direction D1 is connected, a mirror portion 12 that reflects a light L incident on and emitted from the optical fiber 40, and a lens portion 11 through which the light L reflected by the mirror portion 12 passes.

The optical-fiber-coupling portion 13 is located at an end of the lens component 10 in a direction opposite to the first direction D1 and at an end of the lens component 10 in a direction opposite to the third direction D3. The lens component 10 includes a first surface 14 on which the mirror portion 12 is formed, and a second surface 15 extending from an end of the first surface 14 in the first direction D1, along the third direction D3. The first surface 14 extends in the first direction D1 and the second direction D2. The cover 20 faces the first surface 14.

The mirror portion 12 is optically coupled to the optical fiber 40. The mirror portion 12 provides a bent optical path between the optical fiber 40 and the element 70 (for example, the photoelectric conversion element 71) by converting a propagation direction of the light L. The mirror portion 12 converts the propagation direction of the light L emitted from the optical fiber 40 in a direction along the main surface 31 of the substrate 30 to a direction intersecting the main surface 31. The mirror portion 12 may convert the propagation direction of the light L emitted from the photoelectric conversion element 71 in the direction intersecting the main surface 31 to the direction along the main surface 31.

For example, the lens component 10 has a recessed portion 10c formed on the first surface 14. The recessed portion 10c is recessed toward the substrate 30 on the first surface 14. Among the plurality of surfaces defining the recessed portion 10c, a surface located at a position close to the optical fiber 40 is inclined with respect to the optical path of the light L (hereinafter, may be simply referred to as an optical path). The mirror portion 12 is formed by the inclined surface. For example, the lens component 10 is made of resin. The mirror portion 12 is at a boundary portion between resin and air. The surface forming the mirror portion 12 reflects the light L due to the refractive index difference between the material of the lens component 10 and the air inside the recessed portion 10c.

The lens component 10 includes a third surface 16 on which the lens portion 11 is formed, a fourth surface 17 extending in the third direction D3 from an end of the third surface 16 in a direction opposite to the first direction D1, and a fifth surface 18 opposite to the fourth surface 17. The fifth surface 18 extends in the second direction D2 and the third direction D3. The optical-fiber-coupling portion 13 is provided at a position extending in the first direction D1 from an end of the fifth surface 18 in a direction opposite to the third direction D3.

The third surface 16 extends in the first direction D1 and the second direction D2. The third surface 16 faces the main surface 31 of the substrate 30. The fourth surface 17 extends in the second direction D2 and the third direction D3. The third surface 16 and the fourth surface 17 are portions recessed from the second surface 15 in a direction opposite to the first direction D1. The third surface 16 and the fourth surface 17 define the region 10A described above. The lens component 10 includes the region 10A between the lens component 10 and the substrate 30 at a portion other than the optical-fiber-coupling portion 13. The lens portion 11 is formed on the optical path between the optical fiber 40 and the element 70. For example, the lens portion 11 is formed in a convex shape on the third surface 16. The lens portion 11 is located on the optical path between the photoelectric conversion element 71 and the mirror portion 12. The mirror portion 12 is optically coupled to the photoelectric conversion element 71 through the lens portion 11.

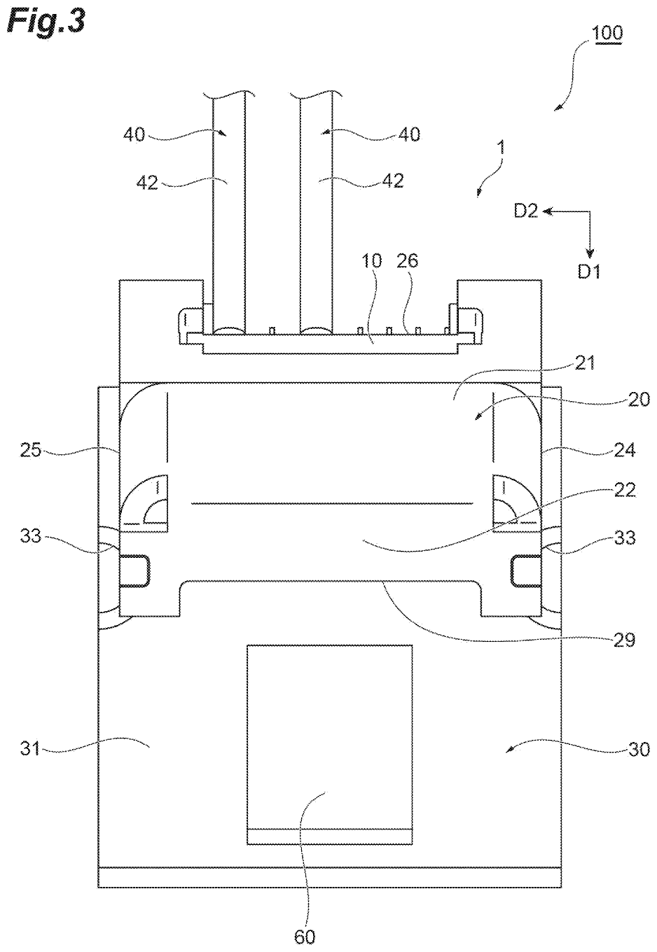

FIG. 3 is a perspective view of the optical component 1 and the optical module 100 when viewed in a direction different from that of FIG. 2. As shown in FIG. 1, FIG. 2 and FIG. 3, the cover 20 is provided to cover a portion of the lens component 10. The cover 20 covers the mirror portion 12 when viewed in the third direction D3. The cover 20 may seal the mirror portion 12. The cover 20 covers, for example, a portion other than the optical-fiber-coupling portion 13 of the lens component 10. The cover 20 is made of, for example, metal. In this case, the cover 20 is manufactured by sheet metal processing or punching. However, the cover 20 does not have to be made of metal, and may be made of resin. The cover 20 may be made of glass or ceramics, and the material of the cover 20 is not particularly limited.

The cover 20 has a top surface 21 extending in the first direction D1 and the second direction D2, and an end surface 22 extending in the third direction D3 from an end of the top surface 21 in the first direction D1. The end surface 22 extends in the second direction D2 and the third direction D3. The end surface 22 faces the region 10A in the first direction D1. The cover 20 has a first side surface 25 extending in the third direction D3 from the end of the top surface 21 in the second direction D2, and a second side surface 24 extending in the third direction D3 from the end of the top surface 21 in a direction opposite to the second direction D2. Each of the first side surface 25 and the second side surface 24 extends in the first direction D1 and the third direction D3. The first side surface 25 and the second side surface 24 are arranged along the second direction D2. The first side surface 25 and the second side surface 24 face the region 10A in the second direction D2.

The cover 20 is provided with a depression 29 that forms a gap between the cover 20 and the substrate 30. The depression 29 is formed between the end surface 22 and the substrate 30. The depression 29 is recessed in a direction opposite to the third direction D3 from an end of the end surface 22 in the third direction D3. The depression 29 is filled with resin. The resin is an adhesive or an encapsulant. For example, the resin is a silicone-based resin, an acrylic-based resin, or an epoxy-based resin.

The cover 20 has a connecting portion 28 connected to the substrate 30. For example, the cover 20 has a plurality of connecting portions 28. The plurality of connecting portions 28 include a first connecting portion 28A located at an end of the cover 20 in the first direction D1 and a second connecting portion 28B located at an end of the cover 20 in a direction opposite to the first direction D1. The substrate 30 includes a through portion 33 that penetrates the substrate 30 in the third direction D3.

For example, in the connecting portion 28, the cover 20 is connected to the substrate 30 through solder at the through portion 33. The first connecting portion 28A protrudes, for example, from each of the first side surface 25 and the second side surface 24 in the third direction D3. The through portion 33 is, for example, a through hole penetrating the substrate 30 in the third direction D3. When viewed in the third direction D3, the through portion 33 is semicircular. For example, at least a portion of the first connecting portion 28A is inserted into the through portion 33. The first connecting portion 28A is soldered to the through portion 33. Thus, when the cover 20 is made of metal, the cover 20 can be ground-connected to the substrate 30, and the cover 20 can be prevented from being an antenna.

The second connecting portion 28B is provided at an end of a third side surface 23 in the third direction D3. The second connecting portion 28B is soldered to the pad 34 provided on the surface of the substrate 30, for example. In this case, ground at the cover 20 can be further stabilized. For example, the first side surface 25 and the second side surface 24 are fixed to the main surface 31 of the substrate 30 with an adhesive. However, at least one of the first side surface 25 or the second side surface 24 may be soldered to a pad (not shown) of the substrate 30. That is, either the first side surface 25 alone, the second side surface 24 alone, or both the first side surface 25 and the second side surface alone may be soldered to the pad. In this case, the number of positions of ground connection of the cover 20 with respect to the substrate 30 can be increased.

The cover 20 is provided with a through hole 27 penetrating the cover 20 in the third direction D3. The through hole 27 is formed for aligning the cover 20 with respect to the substrate 30. As described above, the lens component 10 is transparent, and by viewing the marker formed on the substrate 30 through the through hole 27, it becomes possible to align the cover 20 with respect to the substrate 30. For example, the cover 20 is provided with a plurality of through holes 27. The plurality of through holes 27 are arranged along the second direction D2. As an example, the through hole 27 has a circular shape. However, the through hole 27 may have a shape other than a circular shape, and the shape of the through hole 27 is not particularly limited.

The cover 20 includes the third side surface 23 that extends in the third direction D3 from the end of the top surface 21 in the direction opposite to the first direction D1, and a recessed portion 26 which is a portion where the optical-fiber-coupling portion 13 is exposed. The recessed portion 26 is recessed in the first direction D1 from an end of the third side surface 23 in a direction opposite to the third direction D3. Since the cover 20 has the recessed portion 26, the optical fiber 40 disposed at the optical-fiber-coupling portion 13 can be visually recognized, and the application of an adhesive to the optical fiber 40 disposed at the optical-fiber-coupling portion 13 and the disposition of a component in the optical-fiber-coupling portion 13 can be easily performed.

The optical component 1 includes, for example, a lid 50 that presses the optical fiber 40 disposed at the optical-fiber-coupling portion 13. The lid 50 has a rectangular plate shape, for example. A length of the lid 50 in the second direction D2 is greater than a length of the lid 50 in the first direction D1. The length of the lid 50 in the first direction D1 is greater than a length of the lid 50 in the third direction D3. The lid 50 is disposed in the recessed portion 26 of the cover 20. For example, a height of a top surface of the lid 50 disposed in the recessed portion 26 with respect to the main surface 31 is equal to or less than the height of the top surface 21 with respect to the main surface 31.

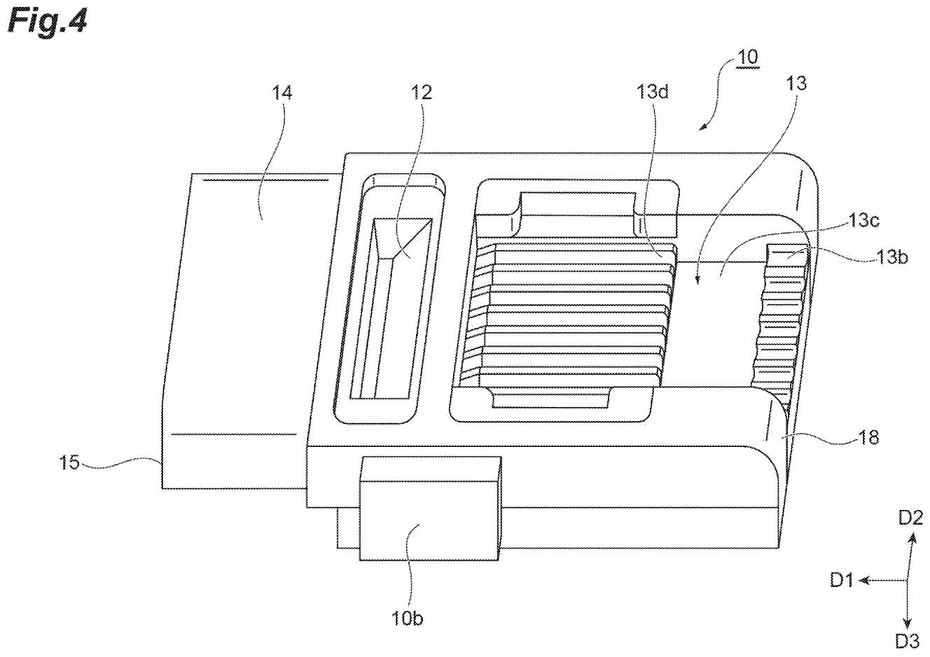

FIG. 4 is a perspective view showing the lens component 10. As shown in FIGS. 2 and 3, for example, the optical module 100 includes a plurality of optical fibers 40. At the optical-fiber-coupling portion 13, the plurality of optical fibers 40 are arranged along the second direction D2. The optical fiber 40 includes a glass fiber 41 and a covering layer 42 covering the glass fiber 41. The optical-fiber-coupling portion 13 includes a first groove 13b on which the covering layer 42 is placed and a second groove 13d on which the glass fiber 41 is placed. For example, the optical-fiber-coupling portion 13 has a flat portion 13c extending from the first groove 13b to the second groove 13d. The flat portion 13c extends in the first direction D1 and the second direction D2.

For example, the optical-fiber-coupling portion 13 is provided with a plurality of first grooves 13b and a plurality of second grooves 13d. The plurality of first grooves 13b are arranged along the second direction D2. The plurality of second grooves 13d are arranged along the second direction D2. For example, the first groove 13b has a U-shape when viewed in the first direction D1, and the second groove 13d has a V-shape when viewed in the first direction D1. A height of a bottom portion (an end in the third direction D3) of the first groove 13b relative to the main surface 31 is smaller than a height of the bottom portion of the second groove 13d relative to the main surface 31. The optical fiber 40, in which the glass fiber 41 is placed on the second groove 13d and the covering layer 42 is placed on the first groove 13b, and the lid 50, which presses the optical fiber 40, are fixed to the optical-fiber-coupling portion 13 with an adhesive.

For example, the lens component 10 is manufactured by injection molding. The lens component 10 has a gate mark 10b. The gate mark 10b is a mark formed when the lens component 10 is injection-molded. The gate mark 10b is a portion where a resin, which is the material of the lens component 10, is cured in a gate into which the resin is injected when the lens component 10 is manufactured. The gate mark 10b is, for example, a gate block protruding in the second direction D2. For example, a shape of the gate mark 10b when viewed in the second direction D2 is a rectangular shape.

Hereinafter, an assembling method of the lens component 10 and a manufacturing method of the optical component 1 will be described. First, the cover 20 is attached to the lens component 10 fixed to the substrate 30 (step of attaching the cover). At this time, a portion of the lens component 10 is covered by the top surface 21 of the cover 20, the end surface 22 is made to face the region 10A in the first direction D1, and the optical-fiber-coupling portion 13 is exposed from the recessed portion 26.

The optical fiber 40 is fixed to the optical-fiber-coupling portion 13 (step of fixing the optical fiber). Specifically, an adhesive for fixing the optical fiber 40 is applied to the optical-fiber-coupling portion 13. Then, the covering layer 42 located at an end of the optical fiber 40 is stripped off to expose the glass fiber 41, the exposed glass fiber 41 is placed on the second groove 13d, and the covering layer 42 is placed on the first groove 13b, for example, the plurality of optical fibers 40 are disposed at the optical-fiber-coupling portion 13. The lid 50 is placed on the glass fiber 41 disposed at the second groove 13d to press the optical fibers 40 (step of pressing the optical fiber). After the above steps, a series of steps of assembling the lens component 10 and manufacturing the optical module 100 is completed.

Effects obtained from the optical component 1 and the optical module 100 according to the present embodiment will be described. The optical component 1 and the optical module 100 include the lens component 10 and the cover 20. The lens component 10 includes the optical-fiber-coupling portion 13, the mirror portion 12, and the lens portion 11. The lens component 10 includes the region 10A covering the element 70 mounted on the substrate 30, and the cover 20 covers the lens component 10 along the third direction D3 which is a thickness direction of the substrate 30. Thus, it is possible to reduce the entry of foreign matter into the lens component 10. The cover 20 has the top surface 21, the first side surface 25, the second side surface 24, and the end surface 22, and the end surface 22 faces the region 10A covering the element 70 in the first direction D1. Thus, since it is possible to make it difficult for foreign matter to enter the region 10A from the outside, it is possible to more reliably reduce the entry of foreign matter into the periphery of the element 70. The first side surface 25 and the second side surface 24 face the region 10A in the second direction D2. Thus, the first side surface 25 and the second side surface 24 also reduce the entry of the foreign matter into the periphery of the element 70.

For example, in the case of an optical component that does not have the cover 20, the element 70 is covered only by the region 10A of the lens component 10, and thus the region 10A may be required to be large in order to prevent foreign matter from entering the element 70. When attempting to be large the region 10A, the length of the lens component 10 in the first direction D1 becomes large, and the optical component cannot be downsized. In contrast, in the case of the optical component 1 that has the cover 20, the top surface 21 covers the lens component 10 in the third direction D3, and the end surface 22 is located at the region 10A in the first direction D1, so that the entry of foreign matter into the region 10A can be reduced without increasing the length of the lens component 10 in the first direction D1. Thus, the lens component 10 can be downsized, which contributes to downsizing of the optical component 1.

The cover 20 may include the third side surface 23 extending in the third direction D3 from the end of the top surface 21 in a direction opposite to the first direction D1, and the recessed portion 26, which is a portion recessed in the first direction D1 from the end of the third side surface 23 in the direction opposite to the third direction D3, and is a portion where the optical-fiber-coupling portion 13 is exposed. In this case, the optical-fiber-coupling portion 13 of the lens component 10 is exposed at the recessed portion 26 of the cover 20. Thus, the optical fiber 40 can be easily connected to the optical-fiber-coupling portion 13.

The cover 20 may be made of metal. In this case, electrical noise can be less likely to leak from the element 70 to the outside of the cover 20. Further, since the cover 20 can be manufactured by bending or punching, the cost of the cover 20 can be reduced. The cover 20 may be made of resin. In this case, since both the lens component and the cover are made of resin, they can be easily bonded with an adhesive.

The cover 20 may be provided with the depression 29 that forms a gap between the cover 20 and the substrate 30. In this case, the depression 29 can reduce degradation of signal characteristics and occurrence of a communication failure due to electrical connection of the cover 20 to the substrate 30.

The lens component 10 may be transparent, and the cover 20 may be provided with the through hole 27 penetrating the cover 20 in the third direction D3. In this case, since the marker (a portion serving as a mark) provided on the substrate 30 can be seen through the through hole 27 of the cover 20, the optical component 1 can be easily aligned with respect to the substrate 30 with high accuracy.

The lens component 10 may be made of resin. The mirror portion 12 may be at the boundary portion between resin and air. The cover 20 may cover the mirror portion 12 when viewed in the third direction D3. The cover 20 may seal the mirror portion 12. In this case, the mirror portion 12 at the boundary portion between resin and air is covered (or sealed) by the cover 20, so that the entry of foreign matter into the mirror portion 12 can be reduced. Thus, it is possible to reduce the decrease in the reflectance of the mirror portion 12 due to the foreign matter.

The substrate 30 may include the through portion 33 that penetrates the substrate 30 in the third direction D3. The cover 20 may have the connecting portion 28 that is connected to the substrate 30 through solder at the through portion 33. In this case, the substrate 30 has the through portion 33, and the cover 20 has the connecting portion 28 connected to the substrate 30. The connecting portion 28 of the cover 20 is connected to the substrate 30 through solder at the through portion 33 of the substrate 30. In this case, the cover 20 can be connected to ground, and the connection strength of the cover 20 to the substrate 30 can be increased.

The cover 20 may have the plurality of connecting portions 28 connected to the substrate. The plurality of connecting portions 28 may include the first connecting portion 28A located at the end of the cover 20 in the first direction D1 and the second connecting portion 28B located at the end of the cover 20 in a direction opposite to the first direction D1. In this case, the cover 20 can be fixed to the substrate 30 at each of the ends of the cover 20 in the first direction D1 and the end of the cover 20 in the direction opposite to the first direction D1, and thus the connection between the cover 20 and ground can be stabilized. The cover 20 is fixed to the substrate 30 at each of the end of the cover 20 in the first direction D1 and the end of the cover 20 in the direction opposite to the first direction D1, and thus the cover 20 can be made less likely to be inclined with respect to the substrate 30.

An optical component and an optical module according to a modification will be described. The configurations of some of the optical components and optical modules according to various modifications to be described later are the same as the configurations of some of the optical component 1 and the optical module 100 described above. In the following, the same reference signs are given to the same configurations as the configurations described above, and the description thereof will be omitted as appropriate.

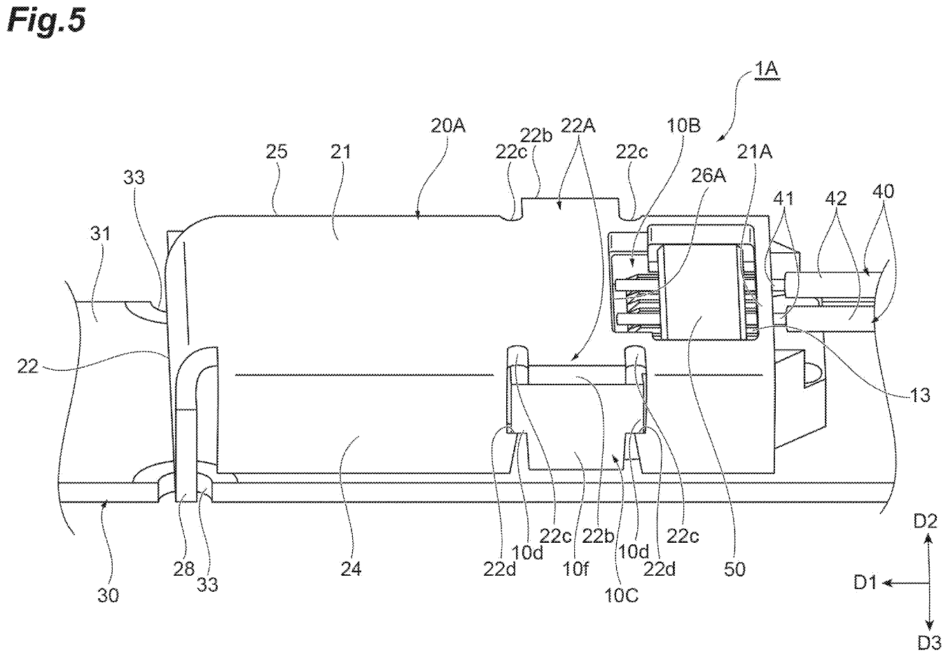

FIG. 5 is a perspective view showing an optical component 1A according to a modification. The optical component 1A includes a lens component 10B and a cover 20A attached to the lens component 10B. The lens component 10B has an engagement portion 10C protruding in the second direction D2. The cover 20A has a latch portion 22A that engages with the engagement portion 10C. The latch portion 22A has a side surface portion 22b extending in the first direction D1 and the third direction D3, a recessed portion 22c recessed from the side surface portion 22b along the second direction D2, and a projecting portion 22d protruding in the first direction D1 between the recessed portion 22c and the substrate 30. The latch portion 22A has a pair of recessed portions 22c arranged along the first direction D1, and the side surface portion 22b protrudes between the pair of recessed portions 22c. The latch portion 22A has a pair of projecting portions 22d arranged along the first direction D1, and the distance (interval) between the pair of projecting portions 22d can be changed by the elasticity of the cover 20A.

The engagement portion 10C protrudes in the second direction D2 as in the gate mark 10b described above. The engagement portion 10C has an extending portion 10f extending in the third direction D3 from the side surface portion 22b and a projecting portion 10d protruding from the extending portion 10f in the first direction D1. The engagement portion 10C has a pair of projecting portions 10d arranged along the first direction D1, and the pair of projecting portions 10d protrude in the direction opposite to each other. The engagement portion 10C may be a gate mark (for example, a gate block) as in the gate mark 10b. In this case, a gate mark, which is a mark formed when the lens component 10B is injection-molded, can be effectively used as the engagement portion 10C.

The pair of projecting portions 22d of the latch portion 22A protrude to face each other. The latch portion 22A is engaged with the engagement portion 10C by widening the gap between the pair of projecting portions 22d by the elasticity of the cover 20A and inserting each of the pair of projecting portions 22d between each projecting portion 10d of the lens component 10B and the substrate 30. Since the projecting portion 22d is inserted between the projecting portion 10d and the substrate 30, the cover 20A is prevented from coming off from the lens component 10B.

The cover 20A has an opening 26A that exposes the optical fiber 40 and the lid 50, instead of the recessed portion 26 described above. The cover 20A has a rod-shaped portion 21A that extends in the second direction D2 at an end portion of the opening 26A in a direction opposite to the first direction D1. The optical fiber 40 extending in the first direction D1 is disposed between the rod-shaped portion 21A and the substrate 30. The assembling method of the optical component 1A is different from the assembling method of the optical component 1 described above in that the optical fiber 40 is fixed to the optical-fiber-coupling portion 13 before the cover 20A is attached to the lens component 10B.

That is, in the assembly of the optical component 1A, the cover 20A is attached to the lens component 10B after the optical fiber 40 is fixed to the optical-fiber-coupling portion 13. As described above, the cover 20A is attached to the lens component 10B by widening the pair of projecting portions 22d and inserting the pair of projecting portions 22d between the projecting portion 10d and the substrate 30. Thereafter, the cover 20A is fixed to the substrate 30 with solder and an adhesive. At the through portion 33, the connecting portion 28 of the cover 20 is connected to the substrate 30 through solder. By fixing the cover 20A to the substrate 30 with solder and an adhesive after the latch portion 22A is engaged with the engagement portion 10C, misalignment of the cover 20A with respect to the substrate 30 and the lens component 10B can be prevented.

In the optical component 1A, the cover 20A has the latch portion 22A that engages with the lens component 10B. Since the latch portion 22A of the cover 20A is engaged with the lens component 10B, the cover 20A can be firmly fixed to the lens component 10B. The lens component 10B has the engagement portion 10C that protrudes from the lens component 10B in the second direction D2 and is engaged with the latch portion 22A. The lens component 10B has the engagement portion 10C with which the latch portion 22A of the cover 20A engages, thereby strengthening the engagement of the cover 20A with respect to the lens component 10B.

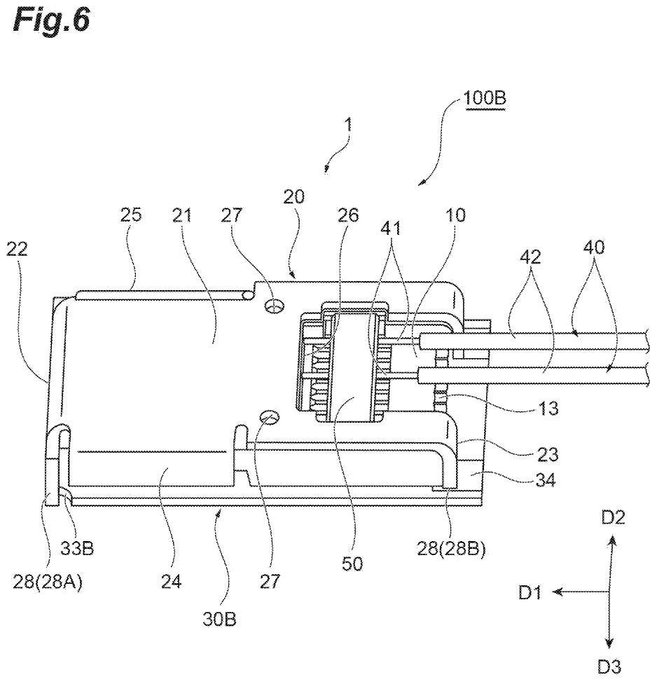

FIG. 6 is a perspective view showing an optical module 100B according to a modification. The optical module 100B includes a substrate 30B having a shape different from the shape of the substrate 30 described above. The substrate 30B has a through portion 33B located at a corner of the substrate 30B, instead of the through portion 33. The through portion 33B is located at an end of the substrate 30B in the first direction D1. When viewed in the third direction D3, the through portion 33B has an arc shape.

At least a portion of the first connecting portion 28A is inserted into the through portion 33B, and the first connecting portion 28A is soldered to the through portion 33B. Thus, in the optical module 100B, as in the optical module 100 described above, when the cover 20 is made of metal, the cover 20 can be ground-connected to the substrate 30B, and the cover 20 can be prevented from being an antenna. As described above, a shape of the through portion of the substrate can be changed as appropriate. The substrate may have a through portion that is circular, elliptical, or polygonal when viewed in the third direction D3.

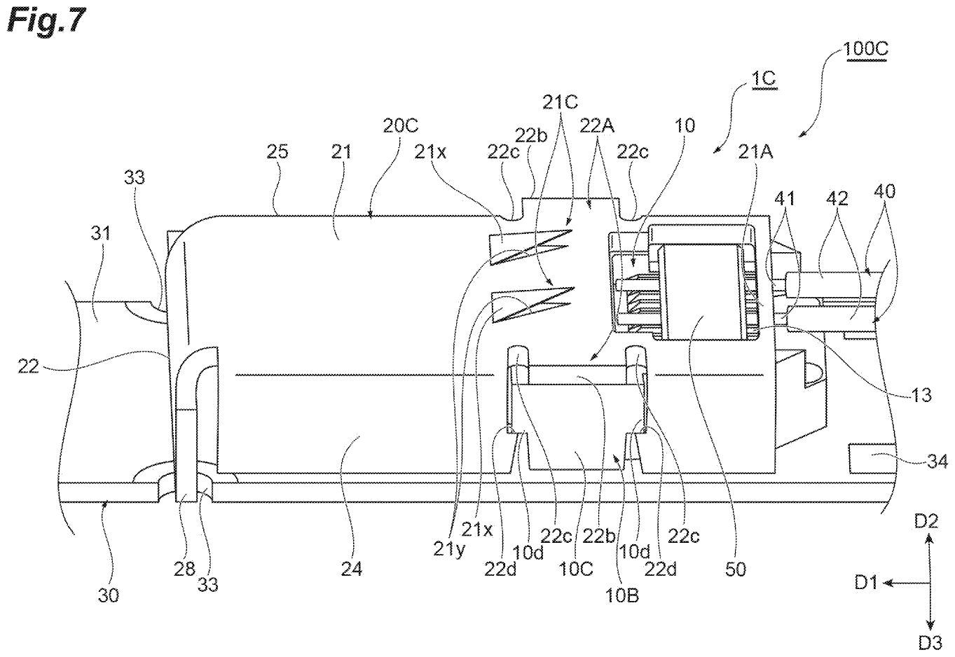

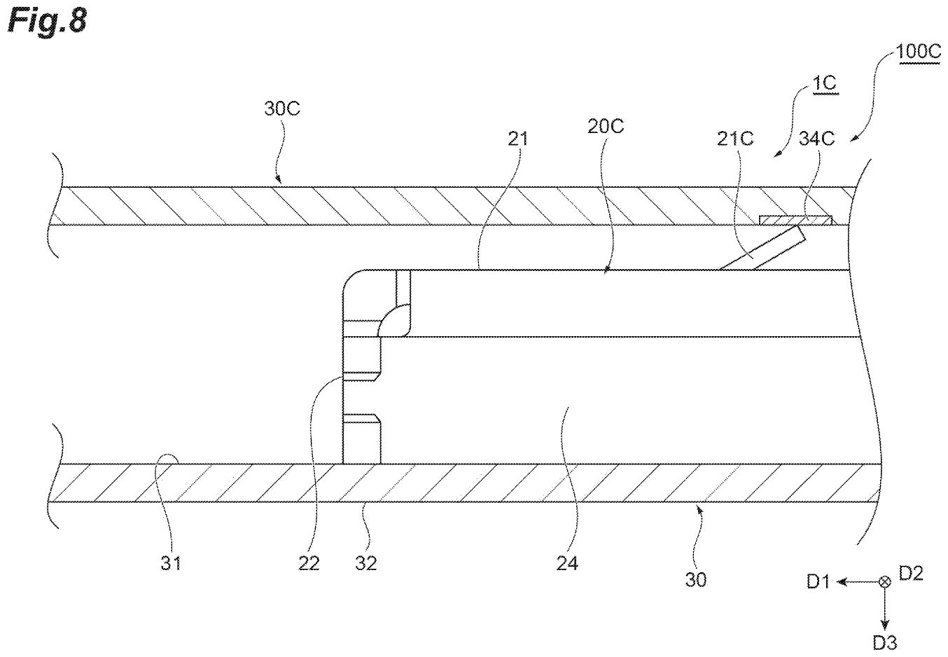

FIG. 7 is a perspective view showing an optical module 100C including an optical component 1C according to a modification. FIG. 8 is a diagram schematically showing the cross section of the optical module 100C when it is cut along a plane extending in the first direction D1 and the third direction D3. As shown in FIG. 7 and FIG. 8, the optical module 100C includes the optical component 1C having a cover 20C different from the cover 20 described above, the substrate 30, and a substrate 30C located in a direction opposite to the third direction D3 of the optical component 1C. In the modification shown in FIG. 7 and FIG. 8, the connecting portion 28 of the cover 20 is connected to the substrate 30 through solder at the through portion 33.

The optical component 1C is located between the substrate 30 and the substrate 30C. The cover 20C has a contacting portion 21C that is in contact with the substrate 30C. The contacting portion 21C is provided with a hole 21y penetrating the top surface 21 in the third direction D3, and a protruding portion 21x protruding from an edge of the hole 21y in a direction opposite to the third direction D3. The protruding portion 21x has elasticity in the third direction D3. For example, the hole 21y has a polygonal shape (for example, a triangular shape), and the protruding portion 21x protrudes from one side of the hole 21y in a direction opposite to the third direction D3.

The protruding portion 21x and the hole 21y are formed by punching, for example. The contacting portion 21C is in contact with a pad 34C of the substrate 30C. As a result, the cover 20C is ground-connected to the substrate 30C. The cover 20C has a plurality of contacting portions 21C. The plurality of contacting portions 21C are arranged along the second direction D2. As described above, in the optical component 1C, the contacting portion 21C of the cover 20C is brought into contact with the pad 34C of the substrate 30C, whereby the cover 20C can be ground-connected to the substrate 30C. Thus, the cover 20C can be prevented from being an antenna.

The embodiments and modifications of the optical component and the optical module according to the present disclosure have been described above. However, the optical component and the optical module according to the present disclosure are not limited to the contents of the above-described embodiment or modification, and may be further modified within the scope of the concept described in the claims. That is, the shape, size, material, number, and arrangement of each part of the optical component and the optical module according to the present disclosure can be appropriately changed within the scope of the above concept. It should be understood that at least one configuration or feature described in each embodiment and modification can be combined with other embodiments and modifications or can be modified in various ways.

For example, in the above embodiment, an example in which the cover 20 covers the lens component 10 having the region 10A covering the photoelectric conversion element 71 and the IC 72 has been described. However, the object covered by the cover 20 can be changed as appropriate. For example, the cover 20 may cover the photoelectric conversion element 71 and the IC 72, or may cover elements other than the photoelectric conversion element 71 and the IC 72. Further, the cover 20 may cover the connector unit 60.

What is claimed is:

1. An optical component configured to be attached to a substrate extending in a first direction and a second direction intersecting the first direction and having a thickness in a third direction intersecting the first direction and the second direction, the optical component comprising:
a lens component including an optical-fiber-coupling portion, a mirror portion and a lens portion, the optical-fiber-coupling portion being a portion to which an optical fiber extending in the first direction is connected, the mirror portion reflecting light emitted from the optical fiber, the lens portion through which the light reflected by the mirror portion passes; and
a cover covering the lens component along the third direction,
wherein, at a portion other than the optical-fiber-coupling portion, the lens component includes a region covering an element mounted on the substrate between the lens component and the substrate, and
wherein the cover includes a top surface extending in the first direction and the second direction and an end surface extending from the top surface in the third direction and facing the region of the lens component in the first direction.

2. The optical component according to claim 1,
wherein the cover further includes a first side surface extending in the third direction from an end of the top surface in the second direction, and a second side surface extending in the third direction from an end of the top surface in a direction opposite to the second direction.

3. The optical component according to claim 1,
wherein the cover includes a third side surface extending in the third direction from an end of the top surface in a direction opposite to the first direction, and a recessed portion that is a portion recessed in the first direction from an end of the third side surface in a direction opposite to the third direction and is a portion where the optical-fiber-coupling portion is exposed.

4. The optical component according to claim 1,
wherein the cover includes a latch portion that engages with the lens component.

5. The optical component according to claim 4,
wherein the lens component includes an engagement portion protruding from the lens component in the second direction and engaged with the latch portion.

6. The optical component according to claim 1,
wherein the cover is made of metal.

7. The optical component according to claim 1,
wherein the cover is made of resin.

8. The optical component according to claim 1,
wherein the cover is provided with a depression that forms a gap between the cover and the substrate.

9. The optical component according to claim 1,
wherein the lens component is transparent, and
wherein the cover is provided with a through hole penetrating the cover in the third direction.

10. The optical component according to claim 1,
wherein the lens component is made of resin,
wherein the mirror portion is at a boundary portion between resin and air, and
wherein the cover covers the mirror portion when viewed in the third direction.

11. An optical module comprising:
the optical component according to claim 1; and
the substrate to which the optical component is attached.

12. The optical module according to claim 11,
wherein the cover includes a connecting portion connected to the substrate through solder.

13. The optical module according to claim 12,
wherein the cover includes a plurality of the connecting portions connected to the substrate, and
wherein the plurality of the connecting portions include a first connecting portion located at an end of the cover in the first direction and a second connecting portion located at an end of the cover in a direction opposite to the first direction.

14. The optical module according to claim 13,
wherein the substrate includes a through portion penetrating in the third direction and a pad provided on a surface of the substrate,
wherein the first connecting portion is connected to the substrate through solder at the through portion, and
wherein the second connecting portion is connected to the substrate through solder at the pad.

15. The optical module according to claim 12,
wherein the substrate includes a through portion penetrating in the third direction, and
wherein the connecting portion is connected to the substrate through solder at the through portion.
